(19) United States
(12) Patent Application Publication
(10) Pub. No.: US 2018/0354169 A1
(43) Pub. Date: Dec. 13, 2018

(54) MANUFACTURING APPARATUS FOR TUBULAR PRODUCT SUCH AS INTERMEDIATE TRANSFER BELT BEFORE CUTTING

(71) Applicant: Konica Minolta, Inc., Chiyoda-ku Tokyo (JP)

(72) Inventor: Yasuki SHIRAKAWA, Toyokawa-shi Aichi-ken (JP)

(21) Appl. No.: 16/002,470

(22) Filed: Jun. 7, 2018

(30) Foreign Application Priority Data
Jun. 9, 2017 (JP) 2017-114639

(51) Int. Cl. B29C 45/00; B29D 29/00; B29C 45/76

(52) U.S. Cl. CPC B29C 45/0053; B29D 29/00; B29L 2031/767; B29C 2793/009; B29C 45/7686

(57) ABSTRACT

A tubular product manufacturing apparatus successively delivers an injection molded tubular shaped body in the delivery direction. The manufacturing apparatus detects a defect on the surface of the molded body passing through the detection position in the delivery direction. The manufacturing apparatus separates a tubular product from the molded body. When a portion having a predetermined length in the molded body passes the detection position without detecting a defect, the manufacturing apparatus separates a tubular product from the molded body, which contains the portion having the predetermined length. When a defect is detected before a portion having the predetermined length in the molded body BT passes through the detection position, the manufacturing apparatus separates the defective tubular product from the molded body. The length of the defective tubular product is shorter than a good product length which is the length of the tubular product including the portion of the predetermined length.

### CROSS-REFERENCE TO RELATED APPLICATIONS

The present application claims priority under 35 U.S.C. § 119 to Japanese patent Application No. 2017-114639 filed on Jun. 9, 2017 the entire contents of which is incorporated herein by reference.

### BACKGROUND

### Technological Field

The present invention relates to a manufacturing apparatus for a tubular product, a method of controlling a manufacturing apparatus for a tubular product, and a control program of a manufacturing apparatus for a tubular product. More particularly, the present invention relates to a manufacturing apparatus for a tubular product for separating a tubular product from an injection-molded tubular shaped body, a method of controlling the manufacturing apparatus for a tubular product and a control program of the manufacturing apparatus of a tubular product.

### Description of the Related Art

Electrophotographic image forming apparatuses include MFPs (Multi Function Peripherals), facsimile machines, copying machines, printers, and the like. An MFP has a scanner function, a facsimile function, a copying function, a function as a printer, a data communication function, and a server function.

An image forming apparatus generally develops an electrostatic latent image formed on an image carrying member with a developing device to form a toner image. The image forming apparatus transfers the toner image to the sheet and then fixes the toner image on the sheet by the fixing device. As a result, the image forming apparatus forms an image on the sheet. Some image forming apparatuses form a toner image by developing an electrostatic latent image on the surface of a photoconductor with a developing device. The image forming apparatus uses a primary transfer roller to transfer the toner image to an intermediate transfer belt. The image forming apparatus secondarily transfers the toner image on the intermediate transfer belt to a sheet by using a secondary transfer roller.

Generally, an intermediate transfer belt is manufactured by the following method. The manufacturer prepares a raw material containing a thermoplastic resin and melts the thermoplastic resin in the raw material. The manufacturer injects the raw material containing the molten thermoplastic resin into a tubular shape using a mold. The manufacturer cools the molded body obtained by injection molding while sending it out, and cuts it to a predetermined length to obtain a tubular product. The manufacturer corrects the shape of the tubular product and cuts the tubular product to the length of the final product of the intermediate transfer belt.

In the following document 1 and so on, a conventional technique relating to a manufacturing method of an intermediate transfer belt is disclosed. The following document 1 discloses a method for manufacturing a seamless belt. A manufacturer melts a resin composition containing a polyetheretherketone resin and conductive carbon black, and stretches it while pushing out from a cylindrical die to form a seamless belt.

In the following document 2 and so on, a conventional technique relating to a method of manufacturing an electrophotographic photoconductor is disclosed. Document 2 below discloses a method for producing an electrophotographic photoconductor including a cleaning step of cleaning a cylindrical substrate by immersing the cylindrical substrate in a cleaning liquid having a temperature higher than the temperature of the outside air, a foreign matter detection step of detecting a foreign substance attached to the surface, and a photosensitive layer forming step of forming a photosensitive layer on the cylindrical substrate.

### PRIOR ART (S)

### Document (s)

### [Reference 1] Japanese Unexamined Patent Application Publication No. 2016-109792

### [Reference 2] Japanese Unexamined Patent Application Publication No. 2012-078728

In the conventional intermediate transfer belt manufacturing method, the molded body is cut into a tubular product having a predetermined length. Thereafter, surface appearance inspection was conducted to check the presence or absence of defects on the surface of the tubular product. If abnormality was found in this surface appearance inspection, the entire tubular product was discarded. For this reason, there is a problem that the amount of discarded is large when there is a defect.

### SUMMARY

The present invention has been made to solve the above problems, and an object thereof is to provide a manufacturing apparatus for a tubular product capable of reducing the amount of waste. It is also to provide a method of controlling the manufacturing apparatus of the tubular product and a control program of the manufacturing apparatus of the tubular product.

To achieve at least one of the abovementioned objects, according to an aspect of the present invention, a manufacturing apparatus of a tubular product reflecting one aspect of the present invention comprises an injection molding unit which feeds an injection molded tubular shaped body continuously in a predetermined delivery direction, a defect detection unit for detecting a defect on a surface of the molded body passing through a predetermined detection position in the delivery direction, a cutting part for cutting the tubular product from the molded body, a tubular product cutting unit for separating the tubular product including a portion of a predetermined length from the molded body by using the cutting part, when the portion of a predetermined length in the molded body passes through the detection position without detecting a defect by the defect detection unit, and a defect portion cutting unit for separating the tubular product including the defect detected by the defect detection unit from the molded body by using the cutting part, when a defect is detected by the defect detection unit before the portion of the predetermined length in the molded body passes through the detection position, wherein a length of the tubular product cut off by the defect portion cutting unit is shorter than a good product length which is a length of the tubular product to be cut by the tubular product cutting unit.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing a method of manufacturing an intermediate transfer belt according to an embodiment of the present invention in order of steps.

FIG. 2 is a perspective view schematically showing a configuration of the tubular product TP1 obtained in step S4 of FIG. 1.

FIG. 3 is a front view schematically showing a configuration of a manufacturing apparatus of an intermediate transfer belt according to an embodiment of the present invention.

FIG. 4 is an upper surface diagram showing the configuration of a cutting part 3 as viewed from the injection molding machine 1 side.

FIG. 5 is a block diagram showing a functional configuration of a manufacturing apparatus of an intermediate transfer belt according to an embodiment of the present invention.

FIG. 6 is a diagram schematically showing a first operation of a manufacturing apparatus of an intermediate transfer belt according to an embodiment of the present invention.

FIG. 7 is a diagram schematically showing a second operation of a manufacturing apparatus of an intermediate transfer belt according to an embodiment of the present invention.

FIG. 8 is a diagram schematically showing a third operation of a manufacturing apparatus of an intermediate transfer belt according to an embodiment of the present invention.

FIG. 9 is a diagram schematically showing a fourth operation of a manufacturing apparatus of an intermediate transfer belt according to an embodiment of the present invention.

FIG. 10 is a diagram schematically showing a fifth operation of a manufacturing apparatus of an intermediate transfer belt according to an embodiment of the present invention.

FIG. 11 is a diagram schematically showing a sixth operation of a manufacturing apparatus of an intermediate transfer belt according to an embodiment of the present invention.

FIG. 12 is a diagram schematically showing a seventh operation of a manufacturing apparatus of an intermediate transfer belt according to an embodiment of the present invention.

FIG. 13 is a diagram schematically showing an eighth operation of a manufacturing apparatus of an intermediate transfer belt according to an embodiment of the present invention.

FIG. 14 is a diagram schematically showing an image of a part of the surface of a molded body BT photographed by a photographing unit 2 according to an embodiment of the present invention.

FIG. 15A and FIG. 15B is a diagram schematically showing a setting panel displayed on an operation display unit 101d in an embodiment of the present invention.

FIG. 16 is a first part of a flowchart showing the operation of the manufacturing apparatus 100 of intermediate transfer belt in one embodiment of the present invention.

FIG. 17 is a second part of a flowchart showing the operation of the manufacturing apparatus 100 of intermediate transfer belt in one embodiment of the present invention.

FIG. 18 is a front view schematically showing a configuration of a manufacturing apparatus of an intermediate transfer belt in a modification of one embodiment of the present invention.

FIG. 19 is a view for explaining a first operation of a manufacturing apparatus of intermediate transfer belt in a modification of one embodiment of the present invention.

FIG. 20 is a view for explaining a second operation of a manufacturing apparatus of intermediate transfer belt in a modification of one embodiment of the present invention.

FIG. 21 is a diagram for explaining a third operation of a manufacturing apparatus of intermediate transfer belt in a modification of one embodiment of the present invention.

FIG. 22 is a diagram for explaining a fourth operation of a manufacturing apparatus of intermediate transfer belt in a modification of one embodiment of the present invention.

FIG. 23 is a flowchart showing the operation of the manufacturing apparatus 100 of the intermediate transfer belt in a modification of the embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

In the following embodiments, the case where the object to be manufactured by the manufacturing apparatus is the tubular product in the preliminary stage of the final product of the intermediate transfer belt (an intermediate transfer belt before cutting to the final length) will be described. The manufacturing object of the inventive manufacturing apparatus may be any tubular product, and may be an intermediate transfer belt itself, a photoconductor, a fixing belt, or the like.

### [Outline of Manufacturing Method of Intermediate Transfer Belt]

First, the outline of the intermediate transfer belt manufacturing method in this embodiment will be described.

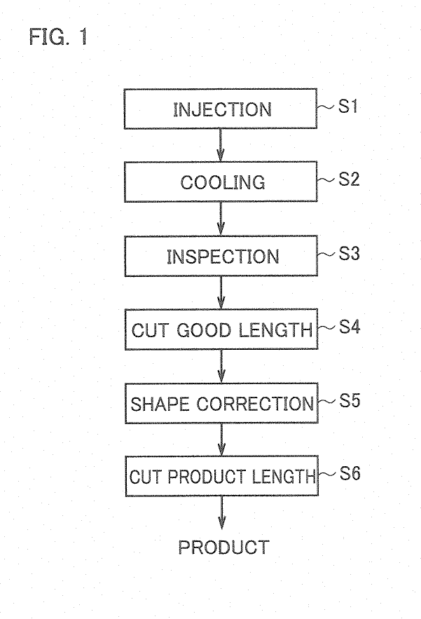

FIG. 1 is a diagram showing a method of manufacturing an intermediate transfer belt according to an embodiment of the present invention in the order of steps.

Referring to FIG. 1, an intermediate transfer belt is a member of an image forming apparatus to which a toner image formed on a photoconductor is primarily transferred. The transferred toner image is secondarily transferred to a sheet. In this embodiment, the intermediate transfer belt is manufactured by the following method.

Molten raw material containing thermoplastic resin is injected into the mold (S1). The injected material is cooled (S2). As a result, an injection-molded tubular (preferably cylindrical) molded body is obtained. Subsequently, the surface of the molded body is inspected while feeding the molded body (S3). If there is no defect as a result of the inspection, the molded body is cut into a tubular product having a predetermined good product length (S4). Next, the shape of the obtained tubular product is corrected (S5). The tubular product is cut into product length which is the length of the final intermediate transfer belt (S 6). This completes the intermediate transfer belt which is the final product.

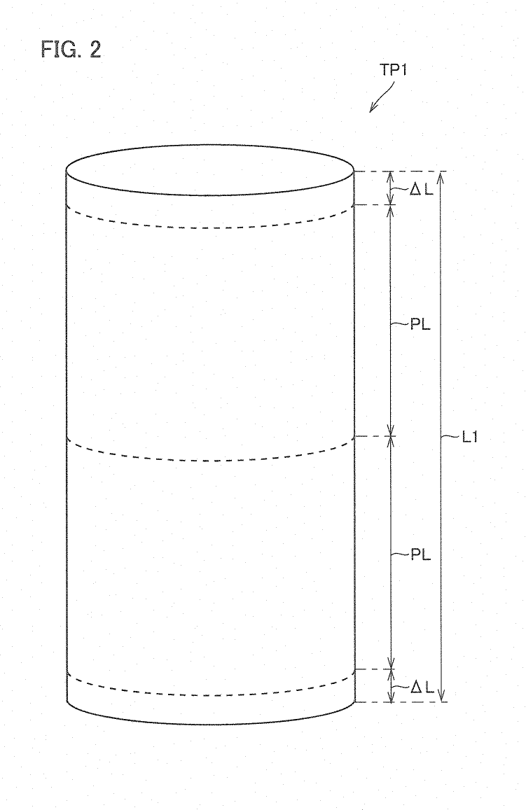

FIG. 2 is a perspective view schematically showing a configuration of the tubular product TP1 obtained in step S4 of FIG. 1.

Referring to FIG. 1 and FIG. 2, the tubular product TP1 has a good product length L1. After the shape is corrected in step S5, the tubular product TP1 is cut into an intermediate transfer belt having a product length PL. Here, a good product length L1 is set so that two intermediate transfer belts can be obtained from one tubular product TP1. Tubular product TP1 is a raw material of two products. Good product length L1 is arbitrary. The number of products obtained from one tubular product TP1 is arbitrary.

Due to the deformation of the molded body at the cutting in step S4, the quality of both end portions of the tubular product TP1 is often inferior to the quality of the central portion of the tubular product TP1. Therefore, when disconnecting to product length PL in step S6, the portion of the predetermined length ΔL at both ends of the tubular product TP1 is removed and discarded. That is, the product is cut out from the central portion of the tubular product TP1.

When a good product length L1 is set such that a plurality of products can be obtained from one tubular product TP1, it is possible to reduce waste in the vicinity of cutting (part of ΔL). In addition, workability of the step (S5) of correcting the shape of the obtained tubular product can be improved.

In the present embodiment, in the manufacturing apparatus of the intermediate transfer belt, the surface of the injection molded tubular shaped body is inspected (step S3 in FIG. 1). Thereafter, the molded body is cut into a tubular product (step S4 in FIG. 1). The configuration and operation of this part will be described.

### [Structure of Manufacturing Apparatus of Intermediate Transfer Belt]

Subsequently, the configuration of the manufacturing apparatus of the intermediate transfer belt in this embodiment will be described.

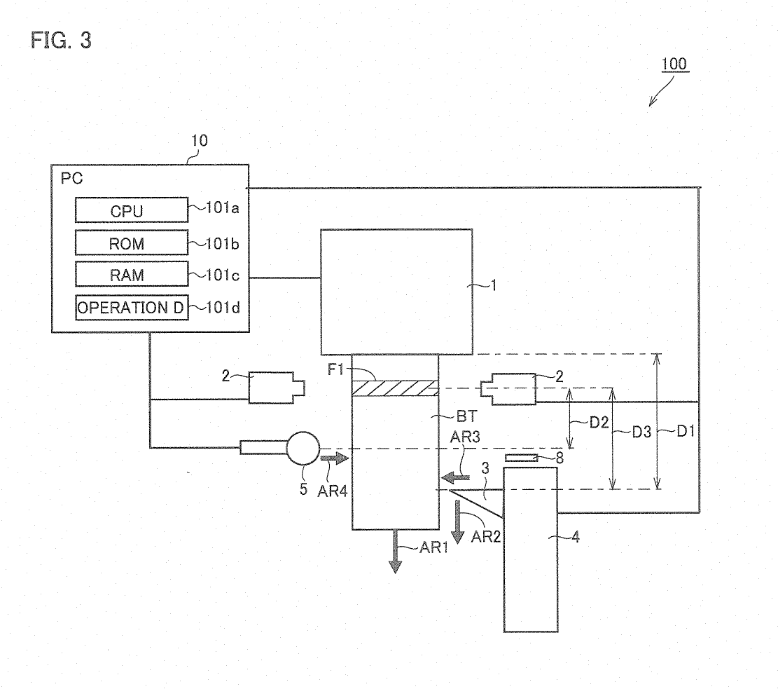

FIG. 3 is a front view schematically showing a configuration of a manufacturing apparatus of an intermediate transfer belt according to an embodiment of the present invention.

Referring to FIG. 3, the manufacturing apparatus 100 (an example of a manufacturing apparatus of a tubular product) of intermediate transfer belt in the present embodiment is mainly provided with an injection molding machine 1 (an example of an injection molding unit), a photographing unit 2 (an example of a defect detection unit), cutting part 3, cutting drive unit 4, marking unit 5, and PC (Personal Computer) 10.

Injection molding machine 1 injection-molds tubular shaped body BT. The injection molding machine 1 continuously delivers the injection molded body BT to the delivery direction AR1. Here, the delivery direction AR1 is a vertically downward direction. The injection molding machine 1 includes a hopper, a heating cylinder, a screw, a die, a cooler, and a tensioning machine. The hopper introduces the raw material containing the thermoplastic resin into the internal space of the heating cylinder. The heating cylinder heats the raw material by the heater in the internal space. The screw mixes the raw materials in the internal space of the heating cylinder and transports it toward the die. The die is provided on the downstream side of the heating cylinder, and the raw material is formed into a required shape (a cylindrical shape in this case). The cooler cools the injected molded body. The tensioning machine sends molded body BT cooled by the cooler to delivery direction AR1.

The photographing unit 2 photographs the surface of the tubular shaped body BT before being cut by the cutting part 3. The photographing unit 2 photographs the surface of the molded body BT passing through the annular detection position (shooting position) F1 in the delivery direction AR1. The photographing unit 2 is configured with, for example, a CCD camera. The photographing units 2 are provided of which the number of the units (here, two units) is necessary for photographing the entire circumference surface of the molded body BT at the detection position F1. Each of the plurality of photographing units 2 (CCD cameras) photographs different parts at the detection position F1.

Cutting part 3 cuts molded body BT in the plane normal to delivery direction AR1. As a result, the cutting part 3 separates the tubular product from the molded body BT. In the present embodiment, cutting part 3 cuts the molded body BT at a position downstream of the detection direction F1 in the delivery direction AR1.

Cutting drive unit 4 drives cutting part 3. As indicated by the arrow AR2, the cutting drive unit 4 moves the cutting part 3 in the direction parallel to the delivery direction AR1 of the molded body BT at the same speed as the delivery speed of the molded body. At the same time, the cutting drive unit 4 cuts the molded body BT with cutting part 3 from the outer diameter side of the molded body BT as indicated by an arrow AR3.

The cutting drive unit 4 may include an adjuster pad for vibration isolation that fixes the position of the cutting part 3.

When a defect is detected by the PC 10, the marking unit 5 contacts the surface of the molded body BT as indicated by an arrow AR4. As a result, the marking unit 5 adds a marking indicating the position of the detected defect to the defective part. The marking unit 5 may be omitted.

The PC 10 is an image processing computer. The PC 10 is connected to each of the injection molding machine 1, the photographing unit 2, the cutting drive unit 4, and the marking unit 5. The PC 10 includes a CPU (Central Processing Unit) 101a, a ROM (Read Only Memory) 101b, a RAM (Random Access Memory) 101c, and an operation display unit 101d. The CPU 101a, the ROM 101b, the RAM 101c, and the operation display unit 101d are connected to each other.

The CPU 101a controls the entire manufacturing apparatus 100 of the intermediate transfer belt. Further, the CPU 101a executes the control program stored in the ROM 101b.

The ROM 101b is, for example, a flash ROM. Various control programs and various fixed data are stored in the ROM 101b.

The RAM 101c is a main memory of the CPU 101a. The RAM 101c is used for temporarily storing data and image data necessary for the CPU 101a to execute the control program.

The operation display unit 101d accepts various operations such as setting the product length PL, setting the injection speed, setting the good product length L1, setting the size of the defective area to be detected as a defect, and the like. The operation display unit 101d also displays various kinds of information.

It should be noted that the manufacturing apparatus 100 of the intermediate transfer belt may further include a marking detection unit 8. The marking detection unit 8 detects the marking attached to the molded body BT on the downstream side of the delivery direction AR1 from the marking unit 5 marking position and upstream of the cutting part 3.

The distance from the exit of the injection molding machine 1 to the initial position of the cutting part 3 (the position on the most upstream side of the delivery direction AR1 in the movable range of the cutting part 3) is set as a distance D1. The distance from detection position F1 to the position where marking unit 5 gives marking is set as distance D2. The distance from detection position F1 to the initial position of cutting part 3 in delivery direction AR1 is set as distance D3.

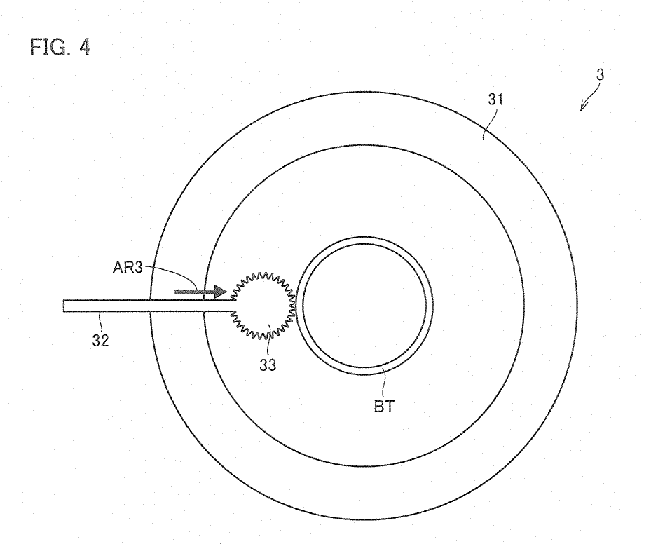

FIG. 4 is an upper surface diagram showing the configuration of the cutting part 3 as viewed from the injection molding machine 1 side.

Referring to FIG. 4, the cutting part 3 includes a rail part 31, a movable part 32, and a cutting tool 33.

The rail part 31 is annular and surrounds the outer periphery of the molded body BT. The center of the rail part 31 and the center of the molded body BT are in the same position.

The movable part 32 extends in the radial direction of the rail part 31 and is movable along the rail part 31 under the control of the image processing unit 103 to be described later. The movable part 32 consists of a linear guide with a stopper and the like.

The cutting tool 33 is attached to the movable part 32. The cutting tool 33 is movable in the radial direction of the rail part 31 (the direction indicated by the arrow AR3 and the opposite direction) along the movable part 32. The cutting tool 33 is a rotary blade and is driven by a cutting drive unit 4.

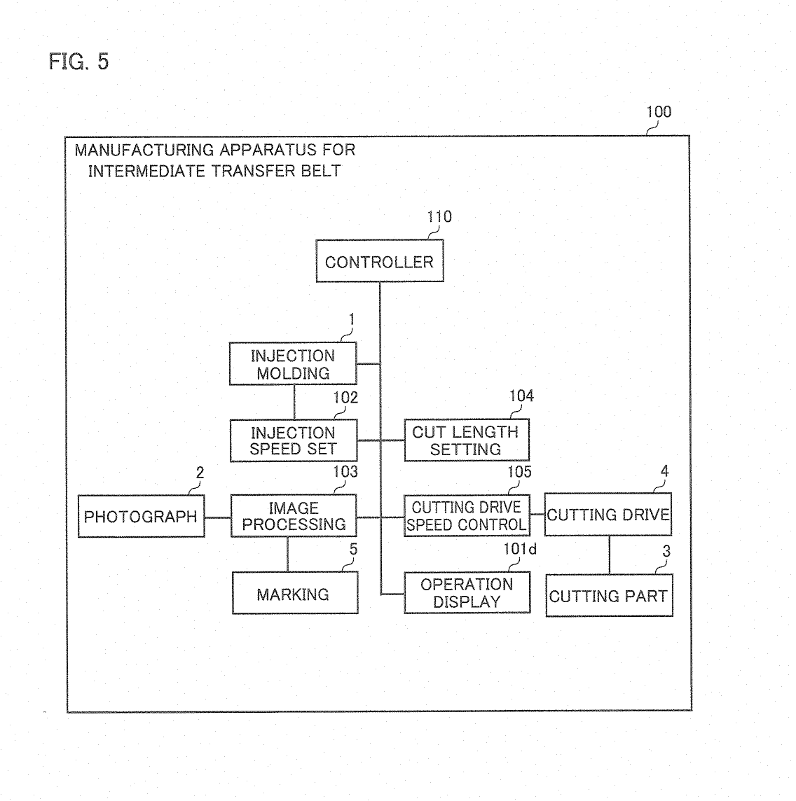

The overall control unit 110 (see FIG. 5) moves the cutting tool 33 in the direction indicated by the arrow AR3 while rotating cutting tool 33. The overall control unit 110 brings the cutting tool 33 into contact with the surface of the molded body BT. Then the overall control unit 110 rotates the movable part 32 and the cutting tool 33 one revolution along the rail part 31 while keeping the cutting tool 33 in contact with the surface of the molded body BT. As a result, the molded body BT is cut. According to this configuration, it is possible to cut the molded bodies BT of various sizes.

FIG. 5 is a block diagram showing a functional configuration of a manufacturing apparatus of an intermediate transfer belt according to an embodiment of the present invention.

Referring to FIG. 5, the manufacturing apparatus of an intermediate transfer belt in the present embodiment has an overall control unit 110 (an example of a tubular product cutting unit and a defect portion cutting unit), an injection speed setting unit 102, an image processing unit 103 (an example of a defect detection unit), a cut length setting unit 104, and a cutting drive speed control unit 105.

The overall control unit 110 controls the entire manufacturing apparatus 100 of the intermediate transfer belt.

Based on the setting values accepted through the operation display unit 101d, the injection speed setting unit 102 sets the injection speed (delivery speed of the molded body BT) of the injection molding machine 1.

The image processing unit 103 controls the operations of the photographing unit 2 and the marking unit 5. The image processing unit 103 processes the image photographed by the photographing unit 2. The image processing unit 103 detects a defect on the surface of the molded body BT based on the image photographed by the photographing unit 2.

Based on the setting values accepted through the operation display unit 101d, the cut length setting unit 104 sets the length of the intermediate transfer belt to be cut by the cutting part 3.

Based on the setting values received through the operation display unit 101d, the cutting drive speed control unit 105 sets the driving speed of the cutting part 3 (here, the speed at which the cutting part 3 moves) by the cutting drive unit 4.

### [Operation of Manufacturing Apparatus of Intermediate Transfer Belt]

Next, the operation of the manufacturing apparatus of the intermediate transfer belt in the present embodiment will be described.

In the intermediate transfer belt manufacturing apparatus 100, the surface of the cylindrical shaped body sent out from the injection molding machine 1 is photographed by photographing unit 2 inline. The manufacturing apparatus 100 of the intermediate transfer belt detects defects on the surface of the molded body BT based on the photographed image. The manufacturing apparatus 100 of the intermediate transfer belt cuts the molded body BT with a length determined based on the presence or absence of a defect (a good product or a defective product).

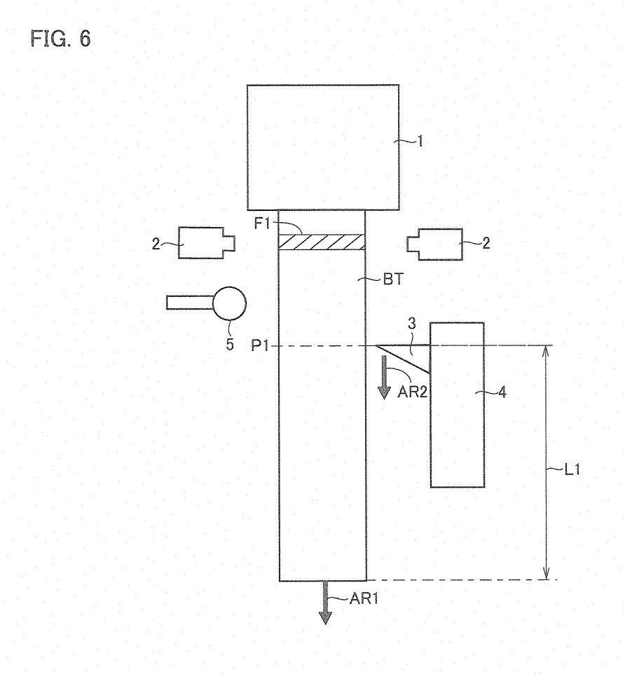

FIG. 6 to FIG. 13 are diagrams schematically showing the operation of the manufacturing apparatus of the intermediate transfer belt according to the embodiment of the present invention.

Referring to FIG. 6, the overall control unit 110 starts delivering the molded body BT and counts the elapsed time from the start of sending out the molded body BT. As a result, the overall control unit 110 calculates the distance from the exit of the injection molding machine 1 to the tip of the molded body BT. The cutting part 3 is located at the initial position.

The image processing unit 103 photographs the surface of the molded body BT passing through the detection position F1 using the photographing unit 2. The image processing unit 103 detects a defect on the surface of the molded body BT based on the photographed image. The image processing unit 103, when detecting a defect, transmits an NG signal to the overall control unit 110. Depending on whether or not the NG signal is received from the image processing unit 103, the overall control unit 110 determines whether or not a defect has been detected.

If the manufacturing apparatus 100 of the intermediate transfer belt is provided with the marking detection unit 8, the overall control unit 110 may determine whether or not a defect has been detected, based on the marking detection result by the marking detection unit 8, instead of judging whether or not a defect is detected by the presence or absence of reception of the NG signal from the image processing unit 103,

Here, the first to third cases will be described.

In the first case, the defect is not detected by the image processing unit 103, and the part having the good product length L1 in the molded body BT passes the detection position F1. In this case, the overall control unit 110 uses the cutting part 3 to cut the molded body BT. As a result, the overall control unit 110 separates the tubular product TP1 having a length of good product length L1 from the molded body BT.

After a predetermined time has elapsed since the part of good product length L1 passed through the detection position F1, the overall control unit 110 starts the movement of cutting part 3. The overall control unit 110 starts moving the cutting part 3 in accordance with the cutting position P1 moving to the delivery direction AR1 separating the tubular product of good product length L1 from the molded body BT. (Cutting position P1 at which the length of the molded body BT existing on the downstream side of the cutting position of the cutting part 3 is good product length L1). The movement direction of cutting part 3 indicated by the arrow AR2 is parallel to the delivery direction AR1 of the molded body BT. The moving speed of the cutting part 3 is the same speed as the delivery speed of the molded body BT.

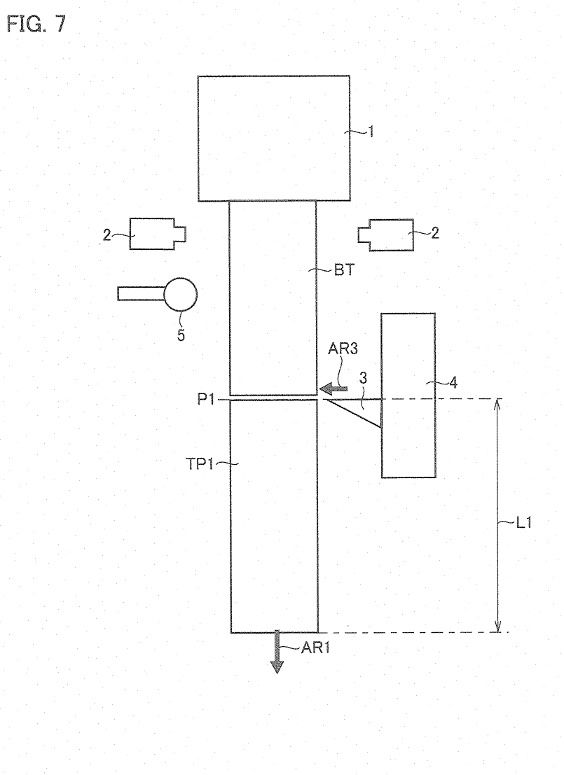

Referring to FIG. 7, the overall control unit 110 moves the cutting part 3 in the direction indicated by the arrow AR3 at a predetermined timing while moving the cutting part 3 in the direction indicated by the arrow AR2. As a result, the overall control unit 110 cuts the molded body BT at the cutting position P1. As a result, the tubular product TP1 having a length of good product length L1 is separated from the molded body BT. The tubular product TP1 is then cut to obtain two products.

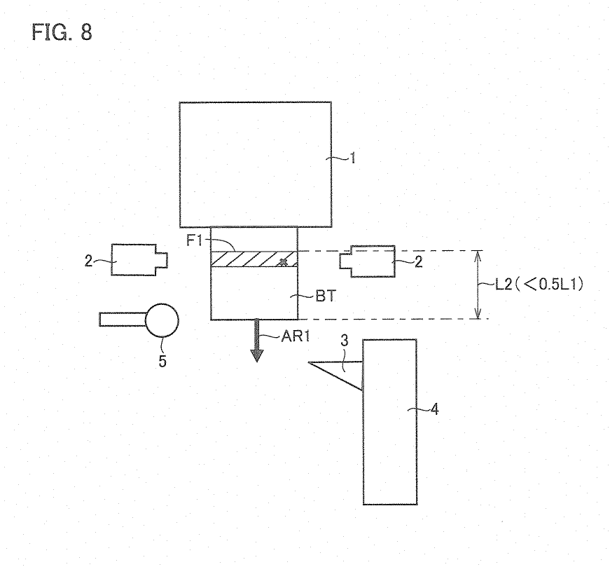

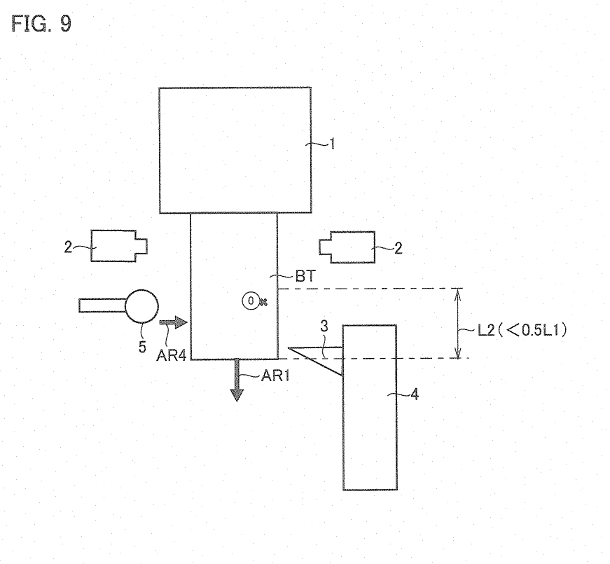

Referring to FIG. 8 and FIG. 9, in the second and third cases, before the part of good product length L1 in the molded body BT passes the detection position F1, the image processing unit 103 detects a defect (X mark in the figures). In this case, the overall control unit 110 uses the cutting part 3 to cut the molded body BT to separate the tubular product having a length shorter than the good product length L1 and containing the detected defect, from the molded body BT.

In the second case, when the portion of the length L2 (L2<0.5L1) shorter than a half of the good product length L1 in the molded body BT passes the detection position F1, the image processing unit 103 detects a defect (X mark in the figures). In this case, the overall control unit 110 moves the marking unit 5 in the direction indicated by the arrow AR4 at the timing when the defect moves to the position where the marking unit 5 marks. The overall control unit 110 marks the position of the defect on the surface of the molded body BT. This marking contains information on the number of products that can be manufactured from the length L2 tubular product containing the defect. Here, since the number of products that can be manufactured from the tubular product of the length L2 including the defect is 0, the number “0” is attached as the marking.

It should be noted that the marking attached by the marking unit 5 may be any marking as long as it indicates the position of the defect, and its shape and position are arbitrary.

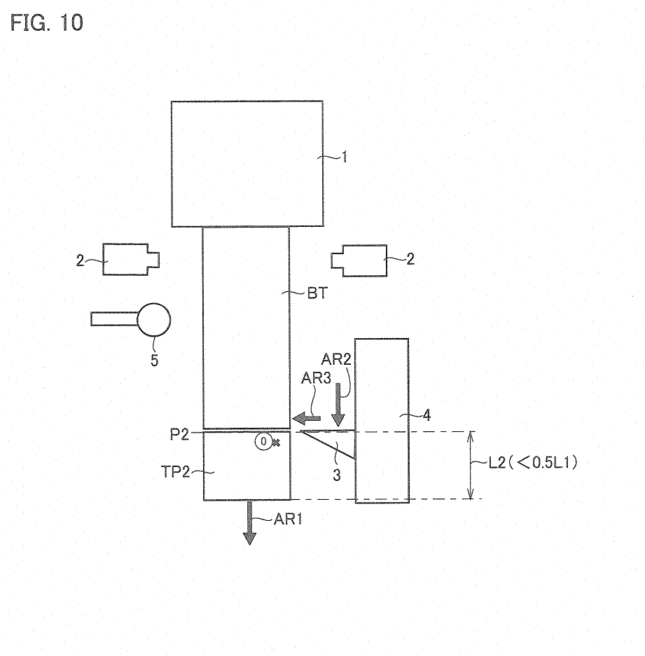

Referring to FIG. 10, after a predetermined time has elapsed since image processing unit 103 detected the defect, overall control unit 110 starts moving cutting part 3. The cutting position P2 in the molded body BT for separating the tubular product TP2 of length L2 containing the defect from the molded body BT moves to delivery direction AR1. In accordance with this, the overall control unit 110 starts the movement of cutting part 3. The cutting position P2 is slightly upstream of the delivery direction AR1 than the defect.

The overall control unit 110 moves the cutting part 3 in the direction indicated by the arrow AR3 at a predetermined timing while moving the cutting part 3 in the movement direction indicated by the arrow AR2. As a result, the overall control unit 110 cuts the molded body BT at the cutting position P2. As a result, the tubular product TP2 having the length L2 is separated from the molded body BT. The tubular product TP2 is then discarded without being used to manufacture the intermediate transfer belt.

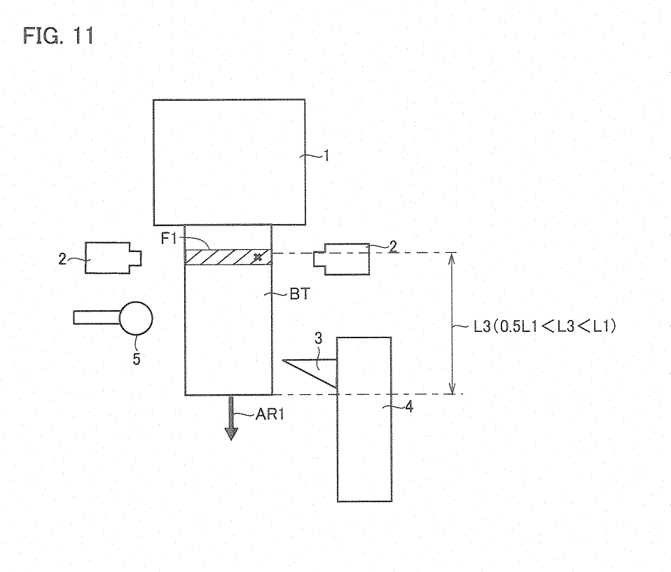

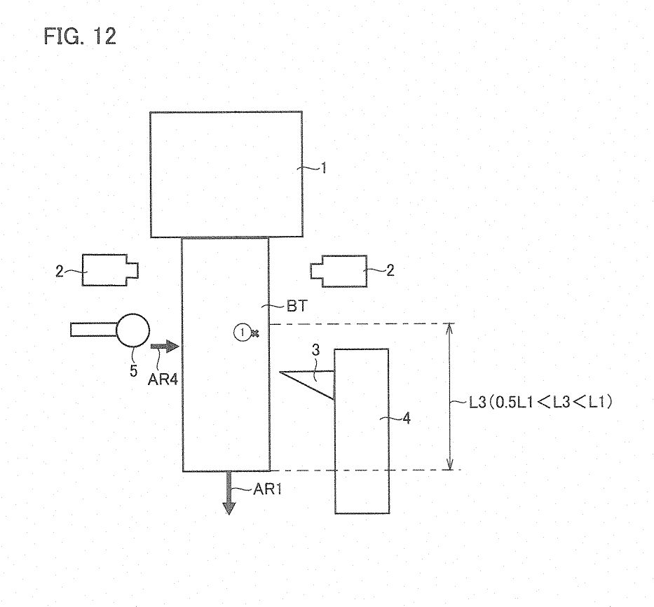

With reference to FIG. 11 and FIG. 12, in the third case, it is assumed that a length L3 (0.5L1<L3<L1) which is longer than a half of the good product length L1 in the molded body BT and shorter than the good product length L1. The part passes through the detection position F1. At this time, the image processing unit 103 detects a defect (X mark in the figures). In this case, the overall control unit 110 moves the marking unit 5 in the direction indicated by the arrow AR4 at the timing when the defect moves to the position where the marking unit 5 marks. The overall control unit 110 marks the position of the defect on the surface of the molded body BT. Here, since one product can be manufactured from the tubular product having the defect length L3, a number “1” is attached as a marking.

In the case where triple of product length PL is set as a good product length L1, and there is a defect in the 2.5 lengths of product length PL, the number “2” is attached as marking.

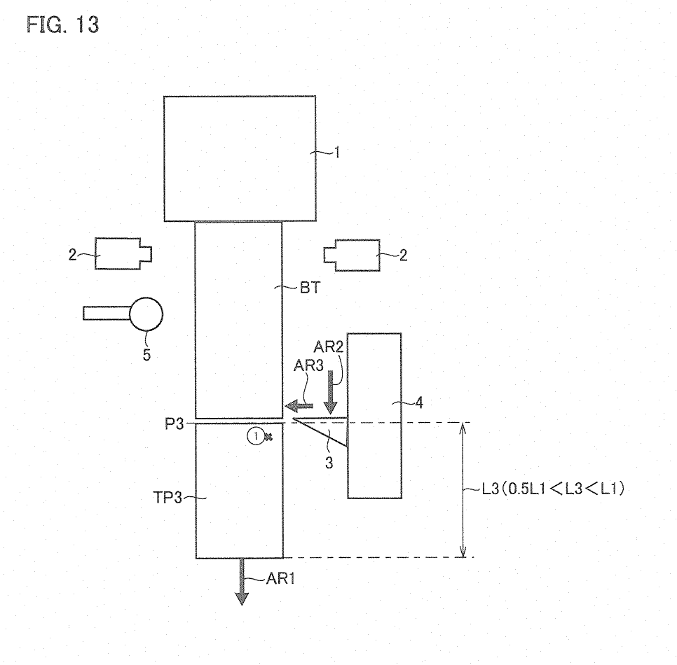

Referring to FIG. 13, after a predetermined time has elapsed since image processing unit 103 detects a defect, overall control unit 110 starts moving cutting part 3. The cutting position P3 in the molded body BT for separating the defective tubular product TP3 of length L3 from the molded body BT moves to delivery direction AR1. In accordance with this, the overall control unit 110 starts the movement of cutting part 3. The cutting position P3 is slightly upstream of the delivery direction AR1 than the defect.

The overall control unit 110 moves the cutting part 3 in the direction indicated by the arrow AR3 at a predetermined timing while moving the cutting part 3 to the movement direction AR2. As a result, the overall control unit 110 cuts the molded body BT at the cutting position P3. As a result, the tubular product TP3 having the length L3 is separated from the molded body BT. The tubular product TP3 is then cut to obtain one product.

In the above operations, the lengths of the tubular products TP2 and TP3 cut in the second and third cases in which defects are detected are L2 and L3 respectively. The lengths L2 and L3 are shorter than the length L1 of the tubular product TP1 cut in the first case in which no defect is detected. In other words, when a defect is detected, the tubular product is separated from the molded body BT before becoming a good product length L1. This makes it possible to reduce the amount of molded bodies discarded when a defect is detected.

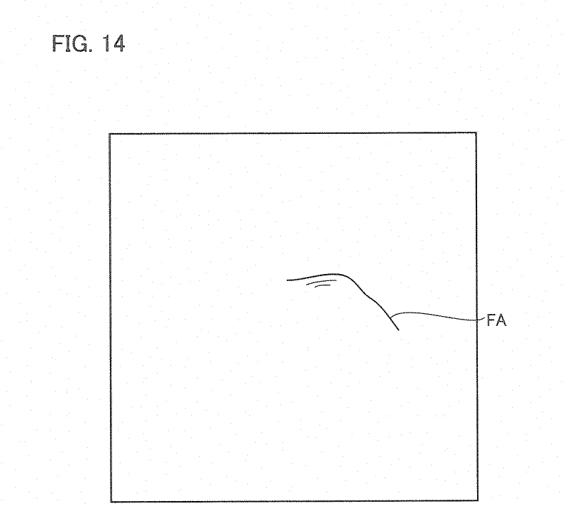

FIG. 14 is a diagram schematically showing an image of a part of the surface of the molded body BT photographed by the photographing unit 2 in one embodiment of the present invention.

Referring to FIG. 14, when defective area FA (local convex portion, concave portion, etc.) exists in the captured image, the defective area FA has a different brightness and the like compared with the other portions. Utilizing the difference in brightness etc., the image processing unit 103 detects the presence or absence of a defective area FA. When defective area FA is detected, the image processing unit 103 measures the size (area, height, etc.) of the defective area FA. When the size of the measured defective area FA exceeds a predetermined threshold value, the image processing unit 103 determines that the defective area FA as a defect.

The image processing unit 103 may previously accept setting of a threshold value of the size of the defective area determined to be defective through the operation display unit 101d. As a result, it is possible to inspect according to the product quality required for the intermediate transfer belt.

### [Method to Set Various Numerical Values]

Next, a method of setting various numerical values will be described.

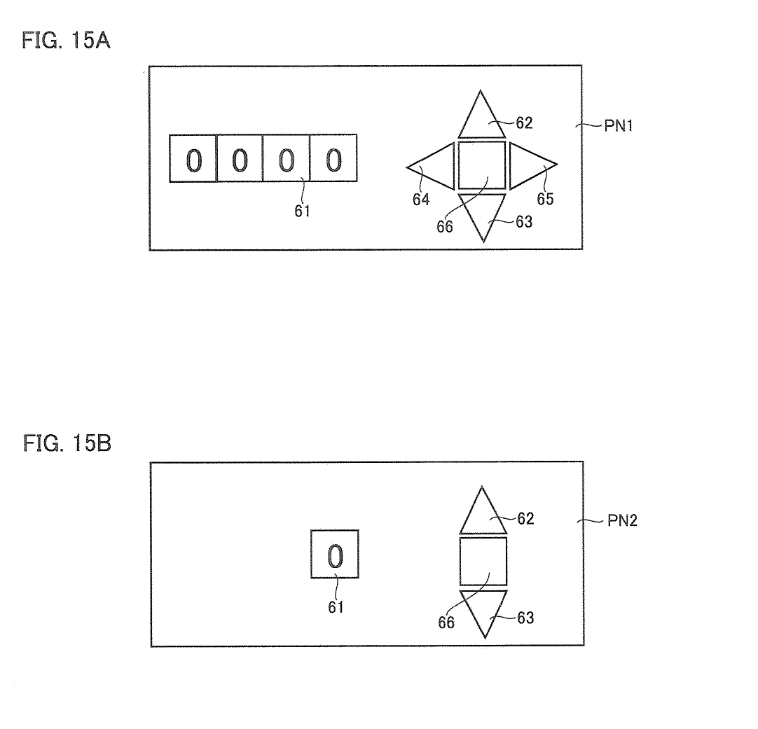

FIG. 15A and FIG. 15B are diagrams schematically showing the setting panel displayed on the operation display unit 101d in the embodiment of the present invention. FIG. 15A shows the injection speed setting panel PN1. FIG. 15B shows number of good products setting panel PN2.

Referring to FIG. 15A, when a predetermined operation is accepted, the operation display unit 101d displays the injection speed setting panel PN1. The injection speed setting panel PN1 is a screen for accepting the setting of the speed at which the injection molding machine 1 sends the molded body BT. The injection speed setting panel PN1 includes a display panel 61 and buttons 62 to 66. On the display panel 61, a four-digit numerical value which is an injection speed (cm/s) is displayed. The displayed numerical value is increased or decreased by pressing the buttons 62 to 65. The button 62 increases the numerical value of the digit to be set on the display panel 61. The button 63 decreases the numerical value of the digit to be set on the display panel 61. The button 64 moves the digit to be set in the left direction on the display panel 61. The button 65 moves the digit to be set in the right direction on the display panel 61. The button 66 is for confirming the set numerical value.

When the button 66 is pressed down, the overall control unit 110 sets the set numerical value as the injection speed (the speed at which the molded body BT is sent out). The overall control unit 110 sets the moving speed of the cutting part 3 at the same speed as the set injection speed.

Referring to FIG. 15B, when the operation display unit 101d accepts a predetermined operation, number of good products setting panel PN 2 is displayed. Number of good products setting panel PN2 is a screen for accepting setting of the number of products to be manufactured from a defectless tubular product L1. Number of good products setting panel PN2 includes a display panel 61 and buttons 62, 63, and 66. On the display panel 61, one digit number of number of good products (pieces) is displayed. The numerical value to be displayed is increased or decreased by pressing the buttons 62 and 63. The button 62 increases the numerical value of the digit to be set on the display panel 61. The button 63 decreases the numerical value of the digit to be set on the display panel 61. The button 66 is for confirming the set numerical value.

The number of good products is the number of products manufactured from a tubular product TP1 having good product length L1. For the number of good products, 1 (piece) or more numerical value is set. When accepting the setting that the good product length L1 is longer than the distance that the cutting part 3 can move with the cutting drive unit 4, the operation display unit 101d may return the accepted setting to zero.

The overall control unit 110, when the button 66 is pressed, calculates the good product length necessary to obtain the set numerical value. The overall control unit 110 sets the calculated value as a good product length L1.

The operation display unit 101d may accept settings relating to the good product length L1. The operation display unit 101d may accept setting of the good product length L1 itself, instead of accepting the setting of number of good products.

### [Flowcharts]

Next, flowcharts showing the operation of the manufacturing apparatus 100 of the intermediate transfer belt in the present embodiment will be described.

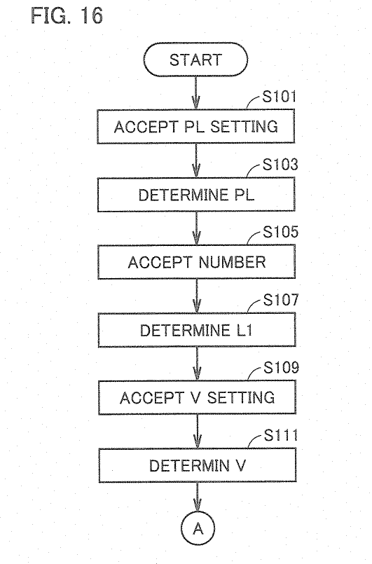

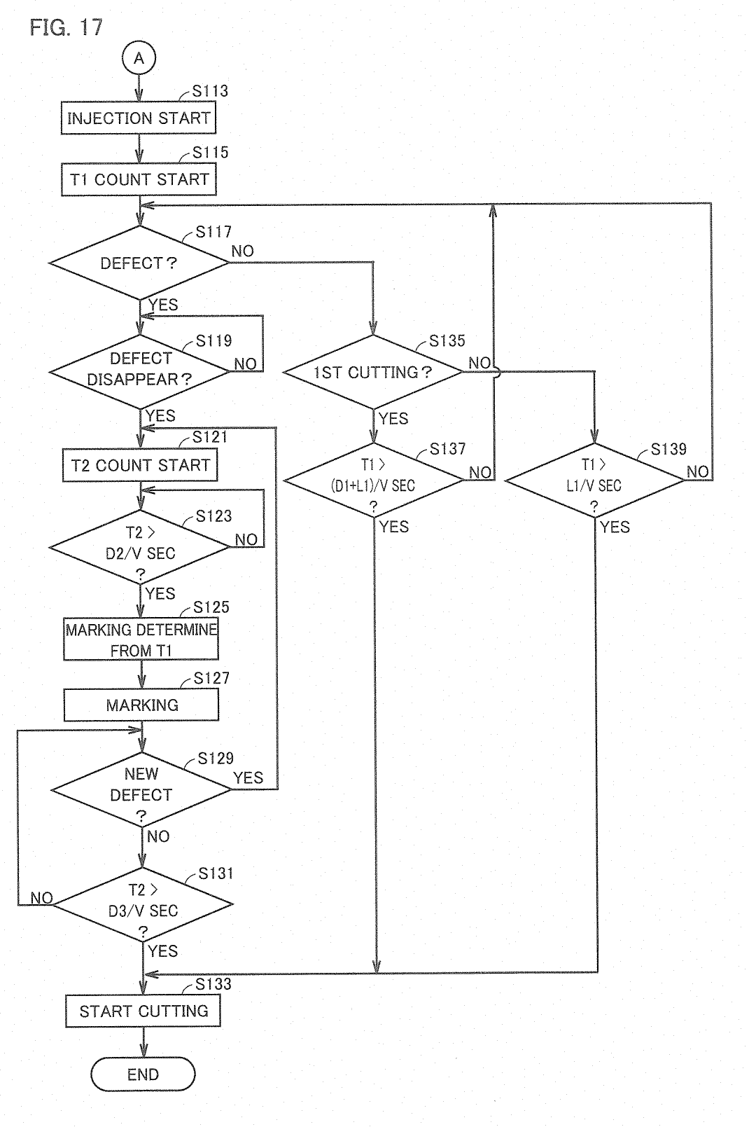

FIG. 16 and FIG. 17 are flowcharts showing the operation of the intermediate transfer belt manufacturing apparatus 100 according to the embodiment of the present invention. This flowchart is realized by the CPU 101a executing the control program stored in the ROM 101b.

Referring to FIG. 16, the power supply of the manufacturing apparatus 100 of the intermediate transfer belt is turned on. The CPU 101a accepts the setting of the product length PL (cutting length) through the operation display unit 101d (S101). The CPU 101a determines the product length PL to be the set value (S103). Next, the CPU 101a accepts the setting of number of good products through the operation display unit 101d (S105). The CPU 101a determines good product length L1 based on the set value (S107). Subsequently, the CPU 101a accepts setting of the injection speed (delivery speed of the molded body BT) V through the operation display unit 101d (S109). The CPU 101a determines the injection speed V to be the set value (S111).

Referring to FIG. 17, following step S111, the CPU 101a starts injection molding (S113). The CPU 101a starts to count the elapsed time T1 from the start of injection molding (S115). Next, the CPU 101a determines whether or not a defect is detected at the detection position F1 (S117).

In step S117, when it is determined that a defect is detected at the detection position F1 (YES in S117), the CPU 101a determines whether or not the defect disappears from the detection position F1 (whether or not the defect is not detected) (S119). The CPU 101a repeats the process of step S119 until it is determined that the defect is no longer visible from the detection position F1.

In step S119, when it is determined that the defect disappears from the detection position F1 (YES in S119), the CPU 101a determines that the defect has passed the detection position F1 and starts counting elapsed time T2 after the defect has passed through the detection position F1 (S121). When counting of the elapsed time T2 has already been started, the CPU 101a resets the elapsed time T2 and starts counting again.

Next, the CPU 101a determines whether the elapsed time T2 has become equal to or longer than the time (D2/V) (s) (S123). The time (D2/V) (s) corresponds to the time required for the detected defect to move the distance D2 from the detection position F1 to the marking unit 5 marking position. The CPU 101a repeats the processing of step S123 until it is determined that the elapsed time T2 has become equal to or longer than the time (D2/V) (s).

If it is determined in step S123 that the elapsed time T2 is equal to or longer than the time (D2/V) (s) (YES in S123), the CPU 101a determines that the defect arrives at the position where the marking unit 5 gives the marking. Based on the value of the elapsed time T1, the CPU 101a determines the type of marking (the number of products that can be manufactured from the tubular product including the defect) (S125). The CPU 101a marks the molded body BT using the marking unit 5 (S127). Next, the CPU 101a determines whether a new defect has been detected at the detection position F1 (S129).

If it is determined in step S129 that a new defect has been detected at the detection position F1 (YES in S129), the CPU 101a proceeds to the process of step S121.

If it is determined in step S129 that a new defect is not detected at the detection position F1 (NO in S129), the CPU 101a determines whether the elapsed time T2 is equal to or longer than the time (D3/V) (s) (S131). The time (D3/V) (s) corresponds to the time required for the detected defect to move the distance D3 from the detection position F1 to the initial position of the cutting part 3 in the delivery direction AR1.

If it is determined in step S131 that the elapsed time T2 is not longer than the time (D3/V) (s) (NO in S131), the CPU 101a proceeds to the process of step S129.

In step S131, when it is determined that the elapsed time T2 is equal to or longer than the time (D3/V) (s) (YES in S131), the CPU 101a determines that the defect has arrived at the initial position of cutting part 3. The CPU 101a starts disconnection (S133), and ends the processing.

If it is determined in step S117 that no defect is detected at the detection position F1 (NO in S117), the CPU 101a determines whether or not it is the first disconnection from the start of injection molding (S135).

In step S135, when it is determined that it is the first cut (cutting had not been performed) from the start of the injection molding (YES in S135), it is assumed that the tip of the molded body BT was present at the outlet of the injection molding machine 1 at the time of starting injection molding. In this case, the CPU 101a determines whether the elapsed time T1 has exceeded the time {(D1+L1)/V} (s) (an example of a first time) (S137). The time {(D1+L1)/V} (s) is equivalent to the time required for the tip of the molded body BT to move a certain distance. The distance corresponds to the sum of the distance D1 from the outlet of the injection molding machine 1 to the cutting position of the cutting part 3 and the good product length L1.

In step S137, when it is determined that the elapsed time T1 is not equal to or more than the time {(D1+L1)/V} (s) (NO in S137), the CPU 101a proceeds to the process of step S117.

In step S137, when it is determined that the elapsed time T1 has exceeded the time {(D1+L1)/V} (s) (YES in S137), the CPU 101a determines that the length of the molded body BT existing on the downstream side of the delivery direction AR1 from the cutting position of the cutting part 3 has become good product length L1. The CPU 101a starts disconnection (S133), and ends the processing.

In step S135, when it is determined that the cutting is not the first cutting after the start of injection molding (NO in S135), it is assumed that the tip of the molded body BT existed at the cutting position of the cutting part 3 at the time of starting the injection molding. In this case, the CPU 101a determines whether or not the elapsed time T1 has exceeded the time (L1/V) (s) (an example of a second time) (S139). The time (L1/V) (s) corresponds to the time required for the tip of the molded body BT to move a distance corresponding to a good product length L1.

If it is determined in step S139 that the elapsed time T1 is not longer than the time (L1/V) (s) (NO in step S139), the CPU 101a proceeds to the processing in step S117.

If it is determined in step S139 that the elapsed time T1 is equal to or longer than the time (L1/V) (s) (YES in S139), the CPU 101a determines that the length of the molded body BT existing on the downstream side of the delivery direction AR1 from the cutting position of the cutting part 3 has become good product length L1. The CPU 101a starts disconnection (S133), and ends the processing.

After the process of step S133, the CPU 101a may reset the time T1 and start counting again, and may proceed to the process of step S117.

### Effect of Embodiment

According to the present embodiment, when a defect is detected, the tubular product is separated from molded body BT with a length shorter than good product length L1. Therefore, it is possible to reduce the discard amount of the molded body BT when there is a defect.

Further, by attaching a marking indicating the position of the defect to the surface of the molded body BT, it is possible to easily distinguish between a good product and a defective product among the tubular products after cutting. Also, the marking includes information on the number of products that can be manufactured from the tubular product. As a result, it is possible to easily cut out products from a defective tubular product after cutting.

Further, by setting the moving speed of the cutting part 3 to be the same speed as the delivery speed of the molded body BT, it is possible to prevent a cutting mistake due to erroneous setting of the moving speed of the cutting part 3. It is also possible to prevent the cutting part 3 from applying an unnecessary force to the molded body BT at the time of cutting.

### [Modification]

Next, a modification of the present invention will be described.

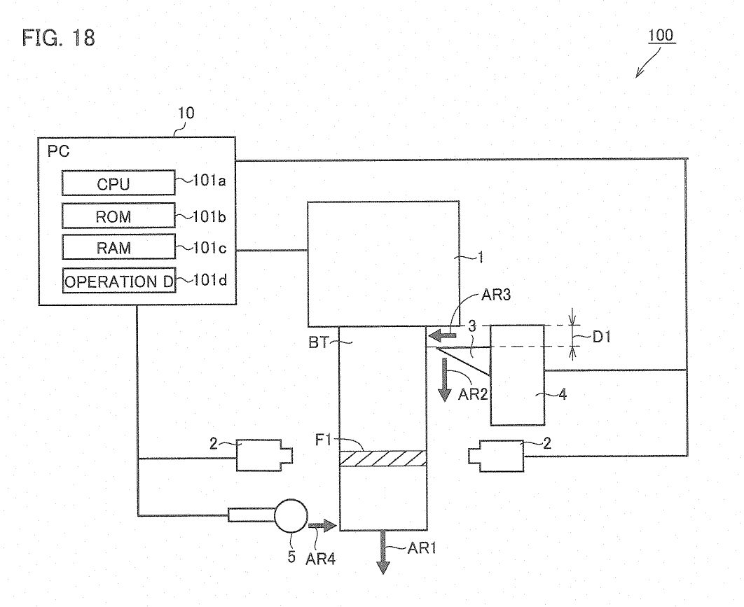

FIG. 18 is a front view schematically showing a configuration of a manufacturing apparatus of an intermediate transfer belt, according to a modification of the embodiment of the present invention.

Referring to FIG. 18, in the intermediate transfer belt manufacturing apparatus 100 according to the present modification, the cutting part 3 cuts the molded body BT at the cutting position on the upstream side of the delivery direction AR1 from the detection position F1.

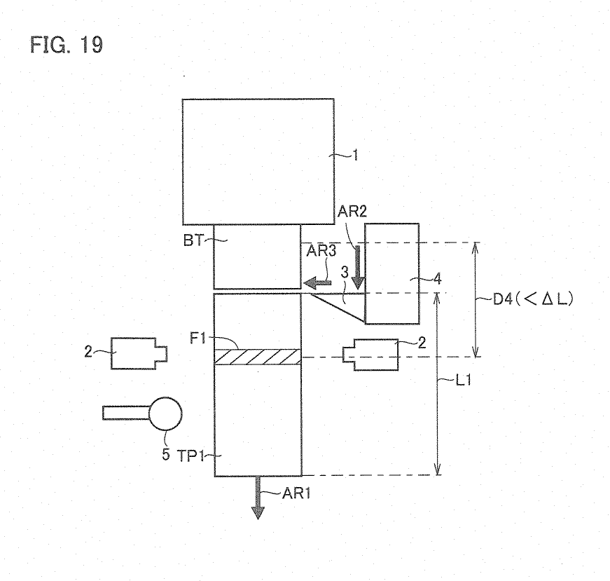

FIG. 19 to FIG. 22 are diagrams for explaining the operation of the manufacturing apparatus of the intermediate transfer belt in the modification of the embodiment of the present invention.

Referring to FIG. 19, the overall control unit 110 starts delivering the molded body BT and counts the elapsed time from the start of sending out the molded body BT. As a result, the overall control unit 110 calculates the distance from the exit of the injection molding machine 1 to the tip of the molded body BT. The cutting part 3 is located at the initial position.

The image processing unit 103 photographs the surface of the molded body BT passing through the detection position F1 using the photographing unit 2. The image processing unit 103 detects a defect on the surface of the molded body BT based on the photographed image. When detecting a defect, the image processing unit 103 transmits an NG signal to the overall control unit 110. The overall control unit 110 judges whether or not a defect is detected by the presence or absence of reception of the NG signal from the image processing unit 103.

Here, the fourth and fifth cases will be described. In the fourth case, a part having good product length L1 in the molded body BT passes through the position of the cutting part 3 along the delivery direction AR1 without detecting a defect by the image processing unit 103. In this case, the overall control unit 110 starts to move cutting part 3 after a predetermined time has passed. The overall control unit 110 moves the cutting part 3 in the direction indicated by the arrow AR3 at a predetermined timing while moving the cutting part 3 to the movement direction AR2. As a result, the overall control unit 110 cuts the molded body BT at the cutting position P1. As a result, the tubular product TP1 having a length of good product length L1 is separated from the molded body BT.

Incidentally, the portion existing within the distance D4 from the initial position of the cutting part 3 to the detection position F1 is a portion separated from the molded body BT as the tubular product TP1 without being inspected for the presence or absence of a defect. Therefore, it is preferable that the distance D4 is as short as possible. Further, by making the distance D4 smaller than the length ΔL (FIG. 2) of the portion to be discarded, it is possible to avoid a situation where a part not inspected for the presence or absence of a defect is included in the product. (In FIG. 19, for convenience of description, the distance D4 is drawn at a ratio larger than the actual length with respect to the length L1).

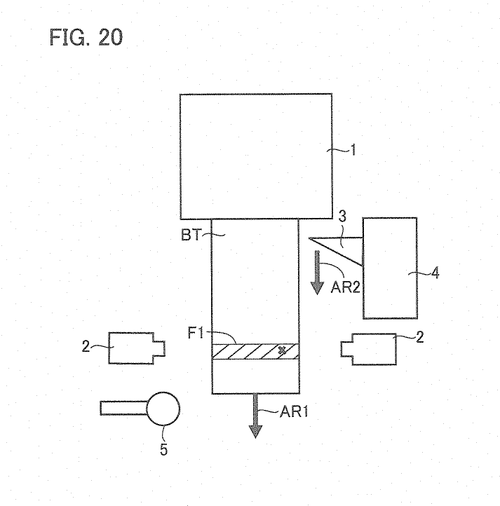

Referring to FIG. 20, in the fifth case, before the part having good product length L1 in the molded body BT passes the position of cutting part 3 along the delivery direction AR1, a defect (x in the figure) is detected by the image processing unit 103. In this case, the overall control unit 110 immediately starts the movement of cutting part 3.

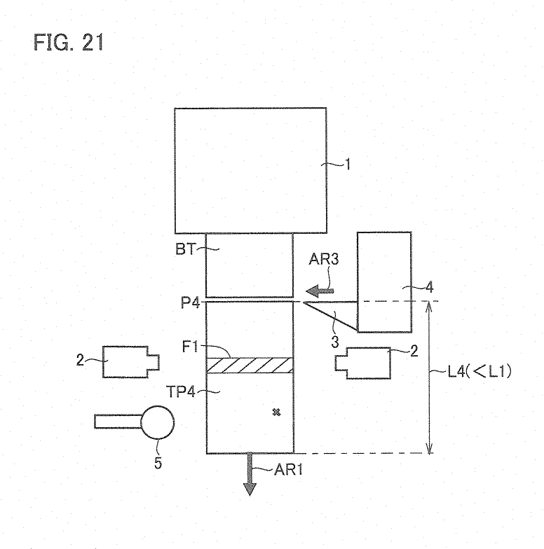

Referring to FIG. 21, the overall control unit 110 moves the cutting part 3 in the direction indicated by the arrow AR3 at a predetermined timing, while moving the cutting part 3 to the movement direction AR2. As a result, the overall control unit 110 cuts the molded body BT at the cutting position P4. As a result, the tubular product TP4 having a length L4 shorter than the good product length L1 is separated from the molded body BT. The tubular product TP2 is then discarded without being used to manufacture the intermediate transfer belt.

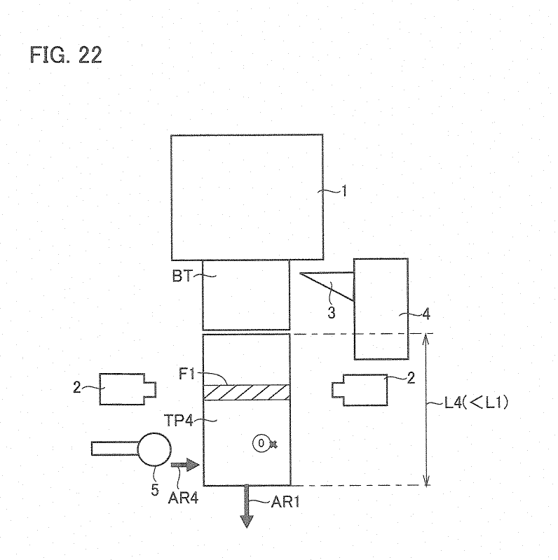

Thereafter, referring to FIG. 22, at the timing when the defect moves to the position where marking unit 5 marks, the overall control unit 110 moves the marking unit 5 in a direction indicated by an arrow AR4. The overall control unit 110 adds necessary markings (here, a numeral “0”) to the position of the defect on the surface of the molded body BT.

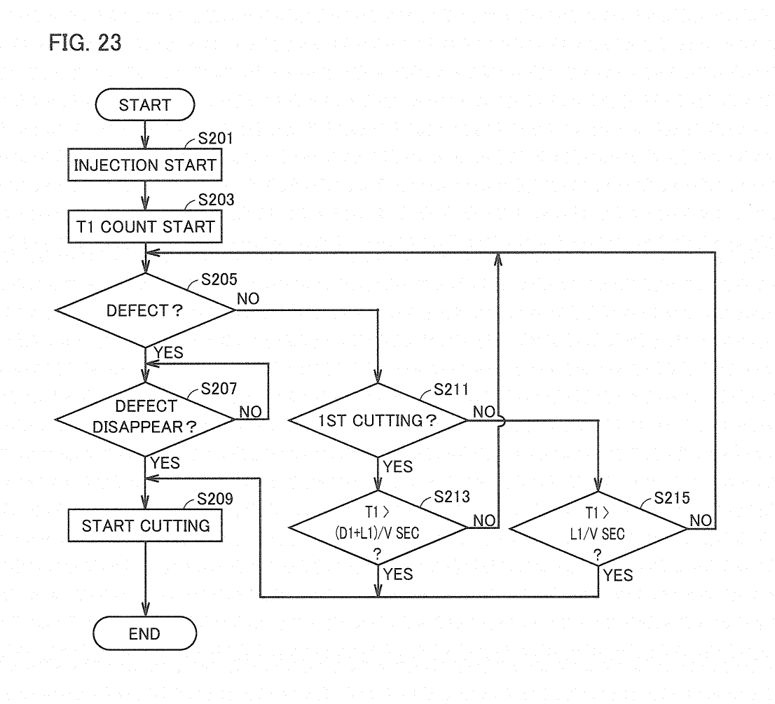

FIG. 23 is a flowchart showing the operation of the manufacturing apparatus 100 of the intermediate transfer belt in the modification of the embodiment of the present invention. This flowchart is realized by the CPU 101a executing the control program stored in the ROM 101b.

Referring to FIG. 23, the power supply of the manufacturing apparatus 100 of the intermediate transfer belt is turned on. The CPU 101a starts injection molding (S201), and starts counting the elapsed time T1 from the start of injection molding (S203). Next, the CPU 101a determines whether or not a defect is detected at the detection position F1 (S205).

In step S205, when it is determined that a defect is detected at the detection position F1 (YES in S205), the CPU 101a determines whether or not the defect disappears from the detection position F1 (whether or not the defect is not detected) (S207). The CPU 101a repeats the process of step S207 until it is determined that the defect is no longer visible from the detection position F1.

In step S207, when it is determined that the defect disappears from the detection position F1 (YES in S207), the CPU 101a determines that the defect has passed the detection position F1. The CPU 101a immediately starts disconnection (S209) and terminates the process.

In step S205, when it is determined that no defect is detected at the detection position F1 (NO in S205), the CPU 101a determines whether or not it is the first disconnection from the start of injection molding (S211).

In step S211, when it is determined that it is the first cutting after the start of injection molding (YES in S211), the CPU 101a determines whether the elapsed time T1 has exceeded the time {(D1+L1)/V} (s) (S213).

If it is determined in step S213 that the elapsed time T1 is not equal to or greater than the time {(D1+L1)/V} (s) (NO in step S213), the CPU 101a proceeds to the process of step S205.

In step S213, when it is determined that the elapsed time T1 has exceeded the time {(D1+L1)/V} (s) (YES in S213), the CPU 101a starts disconnection (S209), and ends the processing.

If it is determined in step S211 that it is not the first cutting after the injection molding is started (NO in S211), the CPU 101a determines whether or not the elapsed time T1 has reached time (L1/V) (s) or more (S215).

If it is determined in step S215 that the elapsed time T1 is not longer than the time (L1/V) (s) (NO in step S215), the CPU 101a proceeds to the process of step S205.

In step S215, when it is determined that the elapsed time T1 is equal to or longer than the time (L1/V) (s) (YES in S215), the CPU 101a starts disconnection (S209), and ends the processing.

According to this modification, since the molded body BT is immediately cut when a defect is detected, it is possible to reduce the discard amount of the molded body BT in the case where there is a defect, without performing complicated control.

### Effect of Embodiment

According to the present embodiment, it is possible to provide a manufacturing apparatus of a tubular product that can reduce the amount of waste. In addition, it is possible to provide a control method of the manufacturing apparatus of the tubular product and a control program of the manufacturing apparatus of the tubular product.

### [Others]

The above embodiments and modifications can be combined with each other.

The processing in the embodiments and the modifications described above may be performed by software or a hardware circuit. Further, it is also possible to provide a program for executing the processing according to the above-mentioned embodiments, and record the program in the recording media such as a CD-ROM, a flexible disk, a hard disk, a ROM, a RAM, a memory card, and so on. The program is executed by a computer such as a CPU. Further, the program may be downloaded to the apparatus via a communication line such as the Internet.

Although the present invention has been described and illustrated in detail, the disclosed embodiments are made for purposes of illustrated and example only and not limitation. The scope of the present invention being interpreted by terms of the appended claims.

What is claimed is:

1. A manufacturing apparatus of a tubular product comprises:
an injection molding unit which feeds an injection molded tubular shaped body continuously in a predetermined delivery direction,
a defect detection unit for detecting a defect on a surface of the molded body passing through a predetermined detection position in the delivery direction,
a cutting part for cutting the tubular product from the molded body,
a tubular product cutting unit for separating the tubular product including a portion of a predetermined length from the molded body by using the cutting part, when the portion of a predetermined length in the molded body passes through the detection position without detecting a defect by the defect detection unit, and
a defect portion cutting unit for separating the tubular product including the defect detected by the defect detection unit from the molded body by using the cutting part, when a defect is detected by the defect detection unit before the portion of the predetermined length in the molded body passes through the detection position, wherein
a length of the tubular product cut off by the defect portion cutting unit is shorter than a good product length which is a length of the tubular product to be cut by the tubular product cutting unit.

2. The manufacturing apparatus of the tubular product according to claim 1, further comprising:
a marking unit for marking the surface of the molded body with a marking indicating the position of the defect detected by the defect detection unit, when the defect was detected by the defect detection unit.

3. The manufacturing apparatus of the tubular product according to claim 2, wherein
the tubular product is a raw material of a plurality of products, and
the marking includes information on a number of products that can be manufactured from the tubular product including the defect detected by the defect detection unit.

4. The manufacturing apparatus of the tubular product according to claim 2, further comprising:
a marking detection unit for detecting the marking affixed to the molding, on the downstream side of a delivery direction with respect to a position where the marking unit applies the marking, wherein
each of the tubular product cutting unit and the defect portion cutting unit determines whether a defect is detected by the defect detection unit, based on a detection result by the marking detection unit.

5. The manufacturing apparatus of the tubular product according to claim 1, wherein
the defect detection unit detects a defective area as a defect, when a defective area having a size equal to or larger than a threshold is detected, and the manufacturing apparatus further comprising:
a threshold setting receiving unit for accepting setting of the threshold.

6. The manufacturing apparatus of the tubular product according to claim 1, wherein
the defect detection unit includes a plurality of cameras that photograph different portions at the detection position.

7. The manufacturing apparatus of the tubular product according to claim 1, further comprising:
a cutting drive unit for moving the cutting part in a direction parallel to the delivery direction, wherein
each of the tubular product cutting unit and the defect portion cutting unit cuts the molded body, while moving the cutting part with the cutting drive unit.

8. The manufacturing apparatus of the tubular product according to claim 7, wherein
the cutting part cuts the molded body at a cutting position on a downstream side of the detection position in the delivery direction, and
the defect portion cutting unit starts to move the cutting part after a predetermined time has elapsed since the defect detection unit detects a defect.

9. The manufacturing apparatus of the tubular product according to claim 7, wherein
the cutting part cuts the molded body at a cutting position on an upstream side of the detection position in the delivery direction, and
the defect portion cutting unit starts to move the cutting part after a predetermined time has elapsed since the defect detection unit detects a defect.

10. The manufacturing apparatus of the tubular product according to claim 7, further comprising:
an injection speed setting receiving unit for receiving a setting of a speed at which the injection molding unit sends out the molded body, wherein
each of the tubular product cutting unit and the defect portion cutting unit cuts the molded body using the cutting part, while moving the cutting part with the cutting drive unit at the same speed as the speed accepted by the injection speed setting receiving unit.

11. The manufacturing apparatus of the tubular product according to claim 7, wherein
the cutting drive unit includes an adjuster pad for fixing a position of the cutting part.

12. The manufacturing apparatus of the tubular product according to claim 1, further comprising:
a cutting determination unit for determining whether or not the molded body has been cut by the cutting part after starting delivery of the molded body by the injection molding unit, wherein
the tubular product cutting unit includes:
a first cutting control unit for cutting the molded body using the cutting part, in a case where it is determined by the cutting determination unit that the molded body was not cut by the cutting part, and when a first time has elapsed since delivery of the molded body was started by the injection molding unit without detecting a defect by the defect detection unit, and
a second cutting control unit for cutting the molded body using the cutting part, in a case where it is determined by the cutting determination unit that the molded body has been cut by the cutting part, and when a second time shorter than the first time has elapsed since a previous cutting, without detecting a defect by the defect detection unit, and
the defect portion cutting unit includes:
a third cutting control unit for cutting the molded body using the cutting part, when judging by the cutting determination unit that the molded body was not cut by the cutting part, and when a defect is detected by the defect detection unit before the first time elapses from the start of the delivery of the molded body by the injection molding unit, and when a third time has elapsed since the defect is not detected by the defect detection unit, and
a fourth cutting control unit for cutting the molded body using the cutting part, when judging by the cutting determination unit that the molded body has been cut at the cutting part, and when a defect is detected by the defect detection unit before the second time elapses from the previous cutting, and when the third time has elapsed since the defect is not detected by the defect detection unit.

13. The manufacturing apparatus of the tubular product according to claim 1, further comprising:
a setting reception unit for accepting the setting relating to the good product length.

14. The manufacturing apparatus of the tubular product according to claim 13, wherein
the tubular product cut off by the tubular product cutting unit is a raw material of one or more products, and
the setting reception unit accepts setting of the number of products to be manufactured from the tubular product to be separated by the tubular product cutting unit, as a setting relating to the good product length.

15. The manufacturing apparatus of the tubular product according to claim 13, wherein
the setting reception unit sets the accepted setting to zero, when accepting a setting such that the good product length is longer than the distance by which the cutting part can be moved by the cutting drive unit.

16. The manufacturing apparatus of the tubular product according to claim 1, wherein
the cutting part includes:
an annular rail part that surrounds an outer periphery of the molded body,
a movable part movable along the rail part, and
a cutting tool attached to the movable part and for cutting the molded body, wherein
the cutting tool is movable in a radial direction of the rail part.

17. The manufacturing apparatus of the tubular product according to claim 1, wherein
the tubular product cutting unit and the defect portion cutting unit are configured by the same means.

18. A method of controlling a manufacturing apparatus of a tubular product, wherein the manufacturing apparatus comprises:
an injection molding unit which feeds an injection molded tubular shaped body continuously in a predetermined delivery direction,
a defect detection unit for detecting a defect on a surface of the molded body passing through a predetermined detection position in the delivery direction, and
a cutting part for cutting the tubular product from the molded body, and the method includes
a tubular product cutting step for separating the tubular product including a portion of a predetermined length from the molded body by using the cutting part, when the portion of a predetermined length in the molded body passes through the detection position without detecting a defect by the defect detection unit, and
a defect portion cutting step for separating the tubular product including the defect detected by the defect detection unit from the molded body by using the cutting part, when a defect is detected by the defect detection unit before the portion of the predetermined length in the molded body passes through the detection position, wherein
a length of the tubular product cut off by the defect portion cutting unit is shorter than a good product length which is a length of the tubular product to be cut by the tubular product cutting unit.

19. A non-transitory computer-readable recording medium storing a controlling program for a manufacturing apparatus of a tubular product, wherein the manufacturing apparatus comprises:
an injection molding unit which feeds an injection molded tubular shaped body continuously in a predetermined delivery direction,
a defect detection unit for detecting a defect on a surface of the molded body passing through a predetermined detection position in the delivery direction, and
a cutting part for cutting the tubular product from the molded body, and the program causing a computer to execute
a tubular product cutting step for separating the tubular product including a portion of a predetermined length from the molded body by using the cutting part, when the portion of a predetermined length in the molded body passes through the detection position without detecting a defect by the defect detection unit, and
a defect portion cutting step for separating the tubular product including the defect detected by the defect detection unit from the molded body by using the cutting part, when a defect is detected by the defect detection unit before the portion of the predetermined length in the molded body passes through the detection position, wherein
a length of the tubular product cut off by the defect portion cutting unit is shorter than a good product length which is a length of the tubular product to be cut by the tubular product cutting unit.
